(19) United States
(12) Patent Application Publication
(10) Pub. No.: US 2004/0025250 A1
(43) Pub. Date: Feb. 12, 2004

(54) Transfer assembly for use by caregivers to lift, support and move the elderly or infirm

(76) Inventor: Guy Bezalel, Givataim (IL)

Correspondence Address: NATH & ASSOCIATES, PLLC, Sixth Floor, 1030 15th Street, N.W., Washington, DC, 20005, US

(21) Appl. No.: 10/636,694

(22) Filed: Aug. 8, 2003

Related U.S. Application Data
(60) Provisional application No. 60/402,537, filed on Aug. 12, 2002.

(51) Int. Cl. A61G 7/08

(52) U.S. Cl. 5/81.1 R

(57) ABSTRACT

In a transfer assembly for use by caregivers to lift, support or move an elderly or infirm patient, a sling supports a posterior portion of the patient during movement thereof, and is anchored toward a lower back portion of the caregiver via connecting straps for supporting the patient. This may be done by attaching the straps to a support worn by the caregiver. On lifting the patient, tension is applied to the connecting straps so as to assist in lifting the patient. The tension applies a counteracting force to the pelvis or hips of the caregiver, which are much less subject to strain that the weaker muscles in the lower back. As a result, lower back strain to the caregiver is significantly reduced.

### RELATED APPLICATION

This application claims the benefit of U.S. provisional application serial No. 60/402,537 filed Aug. 12, 2002.

### FIELD OF THE INVENTION

This invention relates to transfer belts used by caregivers to lift, support and move the elderly or infirm.

### BACKGROUND OF THE INVENTION

Transfer belts or, as they are also known, gait belts allow a caregiver to lift, support and move the elderly or infirm. Essentially, they comprise a belt or harness that supports, and may be worn by, the patient and includes handles for gripping by the caregiver when lifting or moving the patient. Such devices are well known in the art and representative examples taught in the patent literature include the following.

U.S. Pat. No. 5,647,378 (Farnum) issued Jul. 15, 1997 discloses a thin elongate belt formed of an elastic, flexible rubber-like material for lifting an incapacitated person. Fasteners are mounted at the ends of the belt for attaching the ends so that the belt may encircle a patient. The width of the belt between its lateral sides is sufficient so that when worn, the belt extends from the waist to the chest of a wearer. A plurality of flexible handles is fixed to the belt in spaced apart relation.

U.S. Pat. No. 5,297,834 (Vanarnem) issued Mar. 29, 1994 discloses a method and apparatus for lifting and transferring a disabled person to and from a wheel chair. An elongated sheet of material having handles at each end is spread beneath the buttocks of a seated disabled person. An attendant grips the handles so as to support the patient during when moving the patient.

U.S. Pat. No. 5,896,859 (Carroll) issued Apr. 27, 1999 discloses a transfer belt having an adjustable waist belt and a harness strap, both constructed of a pliant material. The harness strap of the belt is affixed proximal the first and second end of the waist belt. Handles may be positioned at the rear of the belt, and/or the belt buckle may be located to one side, beyond the front of the belt portion connecting the ends of the harness. The harness strap is fitted by the user below the wearer's gluteals, and the adjustable waist belt is tightly secured by the user around the wearer's waist. The weight of the wearer can then be shifted by the user by pulling upward on the top portions of the harness strap affixed to the adjustable waist belt, to handles in the front at the harness ends, or to handles affixed to the rear of the belt.

These references are typical of harness belts that are worn by the patient or that support the patient and are equipped with handles for allowing the caregiver to support the patient during movement of the patient. They do not provide means for allowing the patient to support himself on the caregiver during this operation.

This limitation can be overcome by equipping the helper also with a belt so as to allow the patient to hold on to the helper's belt at the same time as the helper holds on to the patient's. Such an approach is disclosed by SCAN Medical Co., Inc. in their product literature relating to their transfer belt sold under the trademark SafetySure. However, there is no suggestion to connect the two belts together. In the absence of any physical connection between the two transfer belts worn by the helper and the patient, the patient's weight is carried partly by the helper and partly by the patient, since the patient is lifted by the helper and, at the same time, grips handles on the helper's transfer belt. However, if the patient slips or otherwise loses his grip, all of his weight is then borne by the helper.

Moreover, in all known transfer belts, during the act of lifting and supporting the patient, the patient's weight is largely supported by the caregiver's back. TFnis may impose severe strain on the caregiver's back, particularly when the caregiver is slight and the patient is heavy. It is well known that incidence of lower back pain is prevalent in those who have the daily task of looking after the infirm and it would clearly be of great benefit to alleviate these problems.

### SUMMARY OF THE INVENTION

It is therefore an object of the present invention to provide a transfer assembly for use by caregivers to lift, support or move an elderly or infirm patient and having a support for allowing the patient to support himself on the caregiver during this operation.

This object is realized in accordance with the invention by a transfer assembly for use by caregivers to lift, support or move an elderly or infirm patient, said transfer assembly comprising:

a sling for supporting a posterior portion of the patient during movement thereof, and having anchoring points for anchoring to a lower back portion of the caregiver via respective straps.

The straps may be integral with the sling or connectable to the sling via the anchoring points and attached to a support adapted to be worn toward a lower back portion of the caregiver that is attachable to the sling for supporting the patient.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a pictorial representation showing a transfer assembly according to the invention;

FIGS. 2 and 3 are pictorial representations showing a detail of a sling for use with the transfer assembly shown in FIG. 1;

FIGS. 4 and 5 are pictorial representations showing a detail of a support belt for use with the transfer assembly shown in FIG. 1; and

FIGS. 6, 7 and 8 are pictorial representations showing use of the transfer assembly shown in FIG. 1 for lifting a patient.

### DETAILED DESCRIPTION OF THE INVENTION

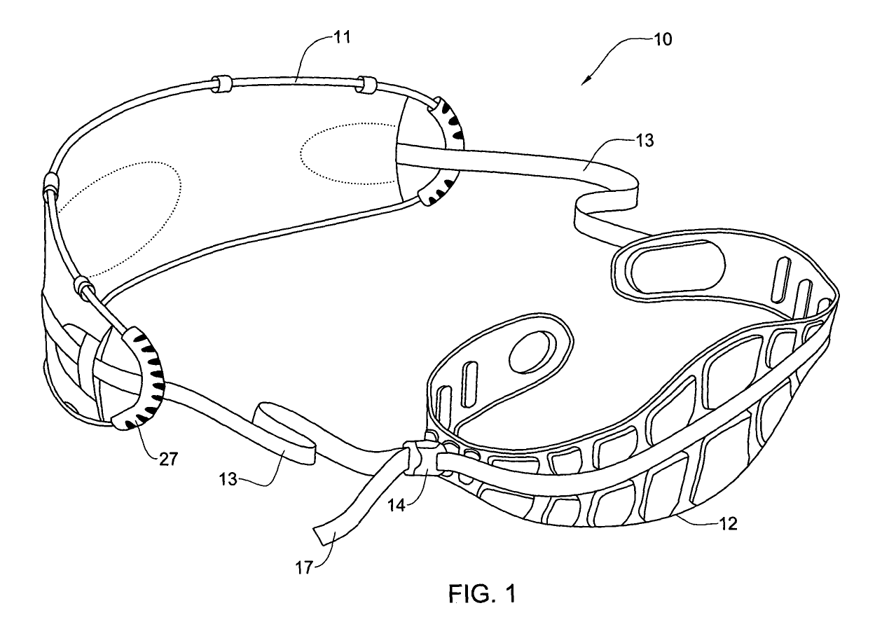

FIG. 1 is a pictorial representation showing a transfer assembly designated generally as 10, comprising a sling 11 for supporting a posterior portion of a patient and a support 12 adapted to be worn toward a lower back portion of a caregiver and being attachable to the sling 11 via a pair of straps 13, having at their ends a pair of clasps 14 for removably engaging corresponding clasps on the support belt 12.

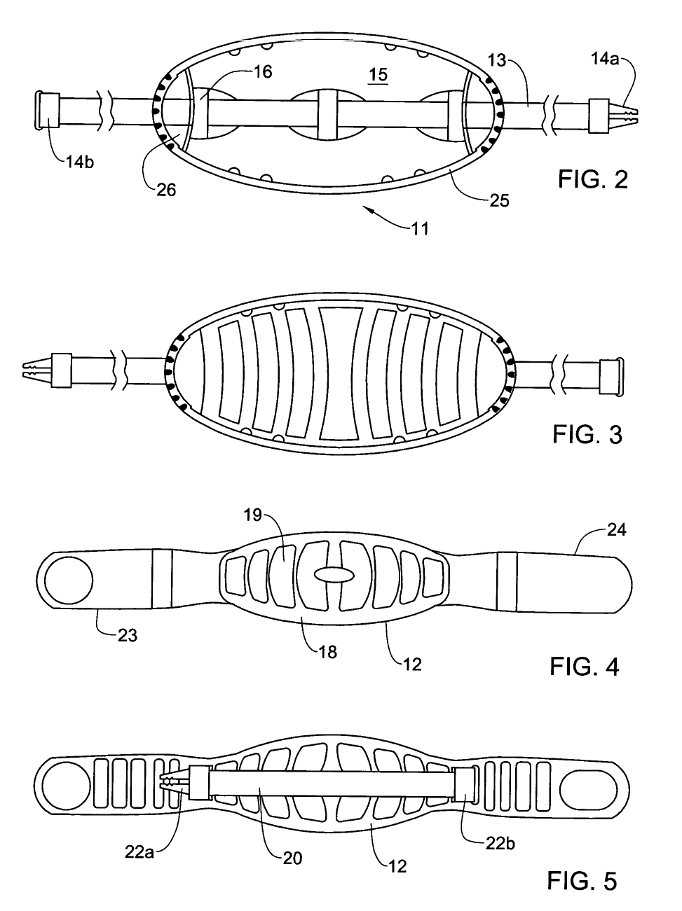

As best seen in FIGS. 2 and 3, the sling 11 comprises a substantially elliptical seat portion 15 formed of sufficient dimension and having sufficient strength to support the patient and having formed therein integral loops 16 for threading the straps 13 therethrough. The straps 13 may, in fact, be formed of a single strap that is threaded through the loops 16 so as to protrude from opposite ends of the sling 11, such that the protruding ends serve as the adjustable straps. In effect, the slots 16 serve as anchoring points for anchoring the straps 13, and thereby the support belt 12, to the sling, although as will be explained below this can be achieved by other means. Thus, in such case, the pair of adjustable straps actually derives from a single strap. Alternatively, a pair of straps may be anchored separately to opposite ends of the sling. In either case, the corresponding ends of the adjustable straps may support male and female clasps 14a and 14b, respectively, for engaging respective clasps associated with the support belt 12. The ends of the straps 13 are threaded through corresponding pairs of slots in the clasps 14a and 14b so that a free end 17 of each strap can be gripped and pulled so as to allow the lengths of the straps to be adjusted in a similar manner to a passenger aircraft seat belt.

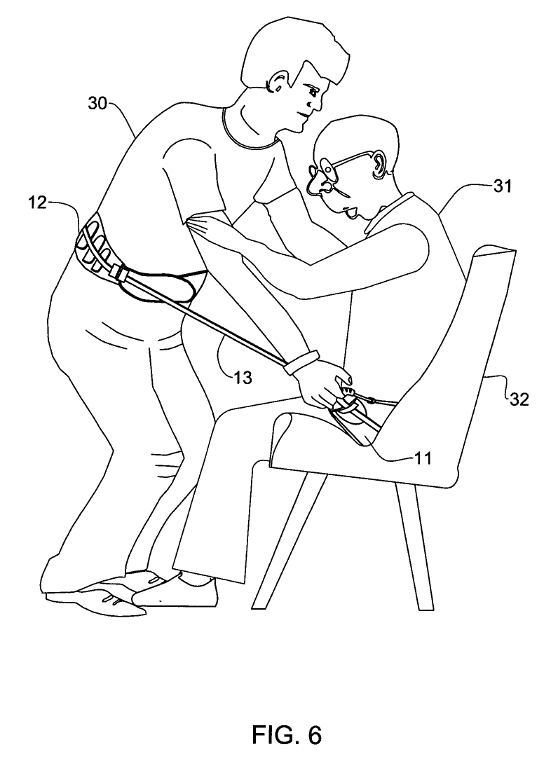

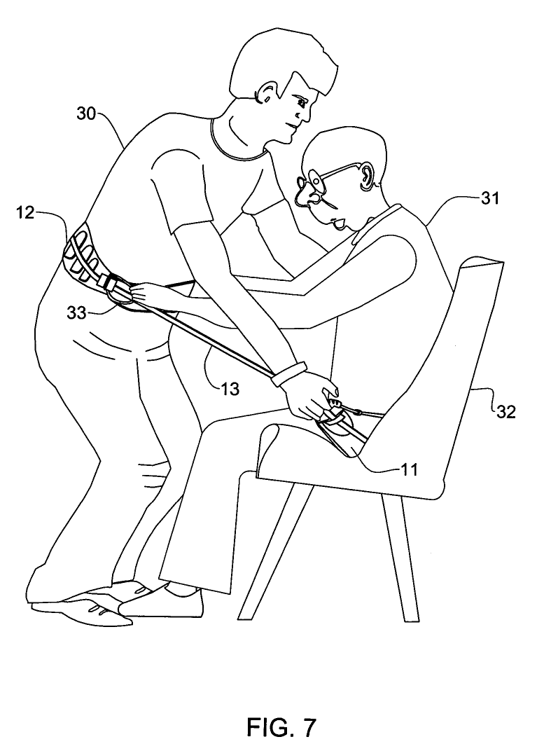

Referring to FIGS. 4 and 5, it is seen that the support belt 12 has on an inside surface 18 thereof resilient pads 19 that serve to grip the caregiver's body so that the support belt does not slip down the caregiver's body during use. A strap 20 is attached to the outside surface of the support belt 12 and is fitted at opposite ends thereof with male and female clasps 22a and 22b, respectively. The clasps 22a and 22b are thus attached to opposite sides of the support belt 12 so as to be accessible from the outside and to engage the corresponding clasps 14b and 14a fixed to the ends of the adjustable strap 13 associated with the sling 11. It will be understood that the figures are intended to convey the manner in which the sling 11 and the support belt 12 co-operate, which constitutes the essential novelty of the invention and are not intended to serve as working drawings. Thus, it should be noted that in a preferred embodiment reduced to practice, the clasps are actually snap buckles capable of withstanding 150 lb force. Likewise, the manner in which the clasps 22a and 22b are attached to the support belt 12 is merely one way to achieve this: the essential thing being that the sling 11 may be anchored to opposite sides of the caregiver's body so as to be lifted when the caregiver raises his hips/pelvic region. Opposite ends 23 and 24 of the support belt 12 are adapted to be adjustably and removably fixed to each other. Most conveniently, this can be done by attaching VELCRO to appropriate mating surfaces of the ends 23, 24 of the support belt 12. VELCRO is a registered trademark of Velcro Industries B.V.

Although in FIGS. 2 and 3, the adjustable strap 13 is shown as being associated with the sling 11, it will be readily apparent that it could equally well be associated with the support belt 12 such that either a pair of separate straps are attached to opposite sides of the support belt for coupling, via appropriate clasps, with corresponding clasps fixed to the sling 11. Likewise, a single adjustable strap could be threadably mounted through loops in the support belt 12 in a complementary manner to the arrangement shown in FIG. 2 associated with the sling 11.

With further reference to FIGS. 2 and 3, it will be seen that the sling 11 is encircled by a rim 25 which may be strengthened by a flexible nylon cord and supports the seat portion 15. The seat portion 15 is truncated at its opposite extremities so as to form corresponding gaps 26 where it is not abutted by the rim 25, so that at opposite ends of the sling 11 the rim 25 forms loops 26, which may be surrounded by a rubber or fabric grip so as to form sling support handles 27, as shown in FIG. 1, for allowing the caregiver to grip the opposite ends of the sling in order to assist him or her in lifting the patient from a sitting position to a standing position, when required.

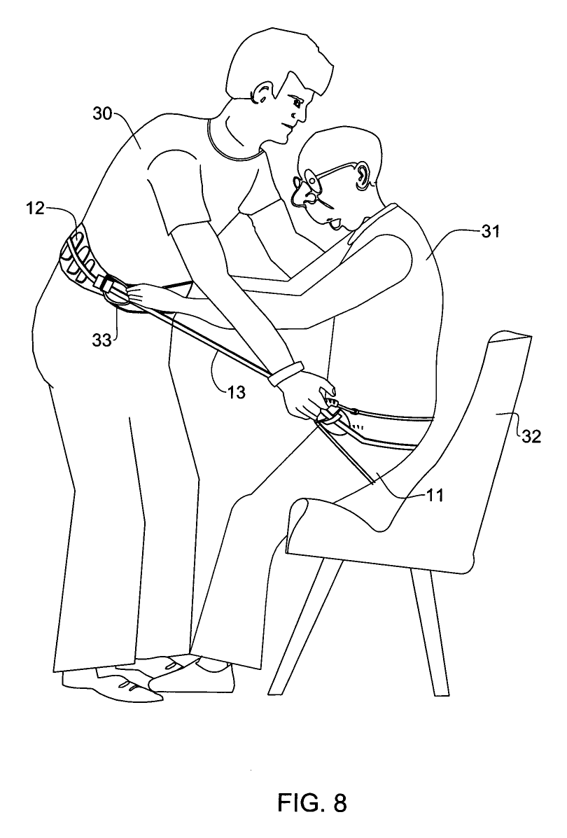

Having described the transfer assembly 10 and its principal components, its manner of use will now be described with particular reference to FIGS. 6, 7 and 8 of the drawings showing a caregiver 30 lifting a patient 31 sitting in a chair 32 using slightly different embodiments of the transfer assembly 10. The slight differences relate to the support belt 12 and will be described shortly. The caregiver first wears the support belt 12 on his lower back portion near his waist and clasps the VELCRO fasteners so that the support belt is properly supported and is prevented from slipping by virtue of the pads 19. He then encourages the patient 31 to lean forward slightly in order that the sling 11 may be eased between the seat portion of the chair 32 and the posterior of the patient. This may more easily be accomplished with another helper but, in any event, may best be performed by a side-to-side sliding movement of the sling 11 so that it is properly positioned beneath the patient's buttocks with the sling support handles 27 accessible to the caregiver 30 on either side of the patient. More particularly, doing this will also ensure that the opposite ends of the adjustable strap 13 protrude from either side of the patient or, in the case that the strap is associated with the support belt 12 (as explained above), that the corresponding clasps 14a, 14b on the sling are accessible. In either case, the respective ends of the adjustable straps 13 on either sides of the patient and the caregiver are connected, whereby opposite sides of the support belt 12 are coupled to opposite sides of the sling 11. The free ends 17 of the straps 13 are then pulled tight through the slots in the corresponding clasps in a similar manner to a passenger aircraft seat belt. This may be facilitated when the straps are associated with the sling 11 rather than the support belt 12, since it is then easier for the caregiver 30 to pull the free ends of the straps 13 toward him, couple the clasps 14a and 14b to the complementary clasps 22b and 22a on the support belt 12 and then pull the straps 13 tight. In either case, after coupling the support belt 12 to the sling 11 via the adjustable straps 13, the caregiver 30 can adjust the length of the straps 13 in order that they be taut. At this initial stage of the procedure, the caregiver 30 will generally be slightly crouching as shown in FIGS. 6 and 7. The extent to which he crouches will depend largely on his height: a tall caregiver will crouch more than a short caregiver. However, as he or she now assumes a more upright position as shown in FIG. 8, tension induced in the straps 13 applies a lifting force to the sling 11 and helps to lift the patient 31 from the chair 32. During this procedure, the straps 13 exert an opposing force on the caregiver 30 which is distributed by the support belt 12 through the pelvis or hips of the caregiver 30 as opposed to conventional approaches where the bulk of the pulling forces are applied to the lower back and arms of the caregiver.

When raising the patient 31 to an upright position, the caregiver 30 may obtain additional support by grasping the handles 27 of the sling and, as shown in FIGS. 7 and 8, the patient may assume additional support by grasping corresponding belt support handles 33 that are optionally mounted on opposite sides of the support belt 12.

It will thus be appreciated that during the act of lifting the patient 31 from the chair 32, tension is applied to the connecting straps 13 so as to assist in lifting the patient. The tension applies a counteracting force to the pelvis or hips of the caregiver, which are much less subject to strain that the weaker muscles in the lower back. As a result, lower back strain to the caregiver is significantly reduced.

Since the vertical component of the tension in the straps aids in lifting the patient, an enhanced lifting force may be obtained by raising the flexible support belt slightly on the caregiver relative to the sling so as to increase an inclination of the adjustable straps relative to a horizontal plane. By such means, the vertical component of the lifting force required for lifting the patient provided by the adjustable straps is increased. In saying this, the support belt should not be lifted too high since the counter-acting force applied to the caregiver would be distributed to the lower back portion rather than the hips/pelvic region.

Although the preferred embodiment has been described with particular reference to lifting a patient from a chair, it will be appreciated that the transfer assembly according to the invention is equally suitable for lifting a patient from any other surface, such as a hospital bed and the like. Likewise, while various embodiments have been described, it will be appreciated that variations will be apparent to those skilled in the art and the invention contemplates all such variations as fall within the scope of the attached claims.

For example, as noted above while it is more convenient for the caregiver if the straps are associated with the sling, they may also be associated with the support belt, although in this case the caregiver has to lean toward the patient in order to secure the clasps at the free ends of the straps to those fixed to the sling. In either case, the complementary clasps 22a and 22b may be attached directly to the support belt (or to the sling, as appropriate). The strap connecting the ends of the clasps 22a and 22b is merely one of many ways to achieve this, while providing a flexible connection to the support belt.

It should also be noted that while the invention has been described with particular regard to a transfer assembly having two co-operating components, the essential feature of the invention resides in the ability to anchor the sling to opposite sides of the caregiver's body so as to be lifted when the caregiver raises his or her hips/pelvic region. Thus, the sling may be provided with anchoring points for coupling straps thereto, and the opposite ends may then be anchored to a belt worn by the caregiver. In such case, the straps could be anchored to the caregiver's trouser belt, for example, via suitable loops or hooks as will be apparent to those skilled in the art. In a variation of such an embodiment, the straps may be integral with the sling and have at free ends thereof suitable clasps or buckles for anchoring to the caregiver.

1. A transfer assembly for use by caregivers to lift, support or move an elderly or infirm patient, said transfer assembly comprising:
a sling for supporting a posterior portion of the patient during movement thereof, and having anchoring points for anchoring to a lower back portion of the caregiver via respective straps.

2. The transfer assembly according to claim 1, wherein the straps are integral with the sling.

3. The transfer assembly according to claim 1, wherein the straps are connectable to the sling via said anchoring points.

4. The transfer assembly according to claim 1, further including:
a support adapted to be worn toward a lower back portion of the caregiver and being attachable to the sling for supporting the patient.

5. The transfer assembly according to claim 4, wherein opposite ends of the support are attached to opposite ends of the sling by a pair of adjustable straps that are adapted to apply a component of a lifting force required to lift the patient.

6. The transfer assembly according to claim 5, wherein the pair of adjustable straps are part of a uniform strap that is threaded through either the sling or the support so as to provide at opposite ends thereof said pair of adjustable straps.

7. The transfer assembly according to claim 5, wherein the pair of adjustable straps are connected to the support or the sling at opposite sides thereof.

8. The transfer assembly according to claim 5, wherein the adjustable straps form part of the support and are provided with respective clasps at opposite ends thereof for mating with corresponding clasps at opposite sides of the sling.

9. The transfer assembly according to claim 5 wherein the adjustable straps form part of the sling and are provided with respective clasps at opposite ends thereof for mating with corresponding clasps at opposite sides of the support.

10. The transfer assembly according to claim 4, wherein the support includes at least one support handle for gripping by the patient.

11. The transfer assembly according to claim 1, wherein the sling includes at least one sling support handle for gripping by the caregiver.

12. A transfer assembly for use by caregivers to lift, support or move an elderly or infirm patient, said transfer assembly comprising:
a flexible support belt having an adjustable fastener;
a sling adapted to support a posterior of the patient and having a pair of sling support handles on opposite sides thereof for gripping by the caregiver; and
an adjustable strap for securing opposite sides of the sling to the support belt and being adapted to apply a component of a lifting force required to lift the patient.

13. The transfer assembly according to claim 12, wherein the adjustable strap includes a pair of clasps at opposite ends thereof for mating with corresponding clasps at opposite sides of the sling.

14. The transfer assembly according to claim 12, wherein the support belt includes at least one belt support handle for gripping by the patient.

15. A method for facilitating a caregiver to lift, support or move an elderly or infirm patient, the method comprising:
supporting on the caregiver a support belt having an adjustable fastener;
disposing a sling underneath a posterior of the patient;
securing opposite sides of the sling to the support belt by a pair of adjustable straps; and
applying force via a pelvic region or hips of the caregiver to lift the patient.

16. The method according to claim 15, further including raising the flexible support belt on the caregiver relative to the sling so as to increase an inclination of the adjustable straps relative to a horizontal plane whereby an increased component of a lifting force required for lifting the patient is provided by the adjustable straps.

17. The method according to claim 15, wherein the sling is equipped with at least one sling support handle and the method further comprises:
gripping the at least one sling support handle by the caregiver to obtain additional support.

18. The method according to claim 15, wherein the support belt is equipped with at least one belt support handle and the method further comprises:
gripping the at least one belt support handle by the patient to obtain additional support.

19. The method according to claim 18, wherein the sling is equipped with at least one sling support handle and the method further comprises:
gripping the at least one sling support handle by the caregiver to obtain additional support.
